(19) United States
(12) Patent Application Publication
(10) Pub. No.: US 2003/0210337 A1
(43) Pub. Date: Nov. 13, 2003

(54) Wireless digital still image transmitter and control between computer or camera and television

(76) Inventor: Wallace E. Hall, Englewood, CO (US)

Correspondence Address: WALLACE E. HALL, 7361 S. Quince St., Englewood, CO, 80112, US

(21) Appl. No.: 10/141,188

(22) Filed: May 9, 2002

(51) Int. Cl. H04N 5/76

(52) U.S. Cl. 348/231.99

(57) ABSTRACT

An improved method for displaying digital still images on a television set. An transmit assembly interfaces with a computer where digital images are stored and a software “slide show” program is running on the computer. A second receive assembly interfaces with a television monitor and has a means to convert digital images to a format with can be displayed on the television monitor. There is a wireless data transmission path between the transmit assembly and the receive assembly. A separate remote control assembly contains a human interface and a wireless data transmission path to the transmit assembly. The system of the computer, television set, transmit assembly, receive assembly and remote control assembly allows a user to remotely and wirelessly control a slide show software program on the computer and display the images on a television screen.

### BACKGROUND

1. Field of Invention

This invention relates to a new method for viewing digital images on a television (TV) set. The method and apparatus allows for wireless transmission of digital images stored on a computer to a television set with wireless control of the picture sequencing with a remote control.

2. Description of the Prior Art

Some higher end models of digital still image camera's include a “composite” analog video output for displaying digital still images on a television (TV) set. However a cable is required to connect the camera to the TV set and it is only convenient to display images, which are stored on the camera's memory.

There are currently products on the market which can wirelessly transmit video and audio signals. These typically use a modulation scheme such as AM or FM to transmit an analog composite video signal and the audio subcarrier. Other products can convert the analog computer monitor video signal (i.e., “VGA”) to a composite video signal such as NTSC and this in conjunction with an analog wireless video transmitter can send wireless images viewable on the computer screen to a remote television screen. If computer “slide show” software is being used with an analog video transmitter as just described, the prior art has used an infrared remote to control the sequencing of the images on the computer. However, the use of infrared which controls the box near the computer requires that the computer be close and “visible” to the remote control and this excludes a lot of applications where the computer is in a different room or location that the TV set. Also, transmission of the video signal using analog means such as FM requires a significant bandwidth and is subject to noise which may show up as “snow” or pixel distortions as the analog video is being scanned on the television screen. Also, as the distance from the transmitter to the TV increases, the noise level also increases with the analog transmission methods.

Other methods for displaying digital images on the television set include a box which sits next to the television set and converts the digital images to NTSC video. The pictures are loaded into the box with a floppy disk and the pictures are sequenced with an infrared remote control. This method is not a convenient interface to the computer and also limits the number of pictures which can be viewed by the memory space on the floppy disk. There is also a software package which also allows digital images to be recoded onto a write-able optical disk in a DVD format. The images can then be viewed on the television set by putting the disk in a DVD player connected to the TV set. Both of these prior art methods do not have the real time accessibility of the digital images residing on the computer hard drive where they tend to be stored and received from the different sources such as the internet or digital still camera's.

The present invention is a method for analog wireless transmission of a computer VGA monitor signal to a television or projector so that the user can monitor the data of the computer through the TV set or projector.

### SUMMARY, OBJECTS AND ADVANTAGES

The present invention relates to a method and hardware for wirelessly transmitting digital images from a computer to a television set with wireless control of the image sequencing such that a user can view images on the television set as long as the computer is within the wireless range of both the control and image transmission physical range. Accordingly, an object of the present invention is to transmit the image in a digital compressed format to improve the quality of the transmitted image and to utilize less radio frequency (RF) bandwidth. A further object of the invention is to utilize wireless control of the image sequencing so the computer and the TV may be in different locations not accessible by an infrared signal. A further object is to utilize infrared for the remote control by implementing a two-way wireless data architecture allowing control commands to be sent back to the computer.

Other and further objects of the invention will be obvious upon an understanding of the illustrative embodiment about to be described or will be indicated in the appended claims, and various advantages not re-ferred to herein will occur to one skilled in the art upon employment of the invention in practice.

### BRIEF DESCRIPTION OF THE DRAWINGS

FIG. 1 is a top level diagram showing the functional blocks of the preferred embodiment.

FIG. 2 is a block diagram of the digital image transmitter and control signal receiver which interfaces with the computer.

FIG. 3 is a block diagram of the RF transmit and receive circuit.

FIG. 4 is a block diagram of the digital image receive assembly which interfaces with the TV set.

FIG. 5 shows details of the receive assembly processing of the digital input data to a video signal.

FIG. 6 is a block diagram of a digital RF transmit only FSK circuit.

FIG. 7 is a block diagram of a digital RF FSK receive only circuit.

FIG. 8 is a block diagram of the wireless remote control.

FIG. 9 is a block diagram of one embodiment of the wireless remote control detector shown in FIG. 2.

FIG. 10 is a block diagram showing an implementation using an IR remote and that requires two way wireless communication between the transmit and receive assemblies.

FIG. 11 is a block diagram showing the transmit assembly functionality to support the configuration shown in FIG. 10.

FIG. 12 is a block diagram showing the receive assembly functionality to support the configuration shown in FIG. 10.

FIG. 13 is a block diagram showing the receive box functionality with an internal hard drive for permanently storing digital image data.

Description of the Referenced Numerals

| | | | |
|---|---|---|---|
| 22 | Transmit assembly | 24 | Receive assembly |
| 26 | Computer | 27 | Computer monitor |
| 28 | External bus connection | 30 | Digital still image camera |
| 32 | Television or TV | 34 | Remote control |
| 36 | Baseband NTSC or PAL video | 38 | Modulated video output |
| 40 | External analog audio input | 42 | Software slide show program |
| 44 | Software data formatter | 46 | USB interface |
| 50 | DC from USB port | 52 | RAM |
| 54 | Microprocessor | 56 | Wireless control detector |
| 57 | Control data | 58 | RF transmit and receive |
| 60 | Digital data antenna | 62 | Wireless control antenna |
| 63 | Picture images on hard drive | 66 | Data in |
| 68 | Data out | 70 | RF in/out |
| 72 | Amplifier | 74 | VCO |
| 76 | Filter | 78 | Divide by N |
| 80 | Phase detector | 82 | Frequency reference |
| 84 | Data input signal | 86 | Data input summer |
| 88 | Amplifier | 90 | Wireless control antenna |
| 91 | Amplifier | 92 | Pre select filter |
| 94 | Mixer | 96 | IF filter |
| 98 | Linear | 102 | FM discriminator |
| 104 | Data slicer | 106 | Data out |
| 108 | RF transmit and receive | 110 | RAM |
| 112 | Microporcessor | 116 | Wall transformer DC power |
| 118 | Video reconstruction block | 122 | Video signal |
| 124 | Analog audio signal | 126 | Baseband audio and video signal |
| 128 | UHF re-modulator | 130 | Wireless control transmitter |
| 132 | Microprocessor | 134 | Key pad |
| 136 | Battery power | 138 | Pre select filter |
| 140 | Amplifier | 142 | Super regenerative AM detector |
| 144 | Clamp | 146 | Data slicer |
| 148 | Amplifier | 150 | VCO |
| 152 | Data input summer | 154 | Dicide by N |
| 156 | Filter | 158 | Data input |
| 160 | Phase detector | 162 | Frequency reference |
| 164 | RF output | 166 | Input RF signal |
| 168 | Amplifier | 170 | Pre select filter |
| 171 | Local oscillator | 172 | Mixer |
| 174 | IF filter | 176 | Limiter |
| 178 | FM discriminator | 180 | Data slicer |
| 182 | Data output | 184 | VCO |
| 186 | Filter | 188 | Phase detector |
| 190 | Divide by N | 192 | Reference frequency |
| 200 | IR emitter | 202 | IR detector |
| 204 | IR digital data | 206 | Hard Drive Memory |
| 208 | Transport stream reconstruction | | |
| 210 | Digital signal processor (image reconstruction) | | |
| 212 | Video Ram | 214 | Audio digital signal processor |
| 216 | Audio output | | |

### DESCRIPTION OF THE PREFERRED EMBODIMENT

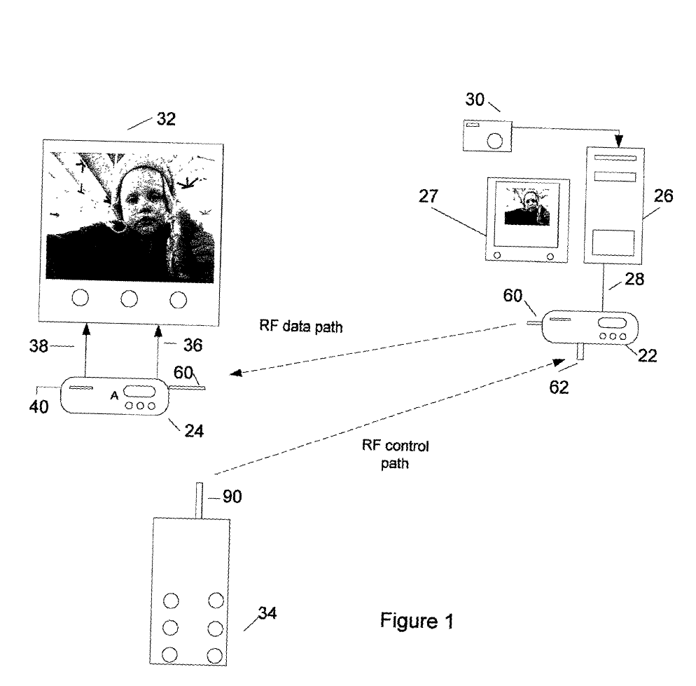

Referring to FIG. 1, a transmit assembly 22 interfaces with a computer 26 (data storage and control device) with monitor 27 through an external bus connection 28 such as USB or a computer serial or parallel bus. A digital still image camera 30 also interfaces with the computer through one of the available bus configurations and is one source of getting digital still images on the computer hard drive 63 or other computer digital memory devices such as floppy drives or optical disk drives. Another common source of getting pictures on the computer 26 hard drive 63 is the Internet either from web site or from electronic mail.

The transmit assembly 22 has a means for receiving digital data such as digital still images from the computer 26 through the external bus connection 28. The transmit assembly 22 has a means for wirelessly transmitting the digital data with digital data antenna 60. In the preferred embodiment, the transmit assembly 22 either has a separate wireless control antenna 62 or uses the digital data antenna 60 for receiving a wireless control signal from a remote control 34.

The receive assembly 24 has an digital data antenna 60 for receiving the wireless digital data from the transmit assembly 22. The receive assembly 24 may also send back wireless digital data to the transmit assembly 22 however this may not always be required for the application. The receive assembly 24 has means for de-compressing the digital data and converting the digital image data to an analog video format such as NTSC. The video may be sent to the TV 32 or video monitor as direct baseband NTSC or PAL video 36 or re-modulated to one of the standard VHF or UHF channels on the modulated video output 38. The video signal interface to the TV 32 could also be RGB or a digital format such as CCIR601. An external analog audio input 40 allows an audio/video signal to be sent to the TV 32.

The remote control 34 has a user interface which is normally push buttons and contains a means for wirelessly transmitting the generated control signals from its wireless control antenna 90 to a wireless receive function in the transmit assembly 22.

The preferred embodiment is then a computer program running on the computer 26 which is controlled by commands from the remote control 34 which are wirelessly transmitted to the transmit assembly 22 and then sent to the computer and software program through the external interface 28. The computer program may also be launched or opened by commands sent from the remote control 34. The software program then sends digital still images from the computer to the transmit assembly 22 where they are wirelessly transmitted to the receive assembly 24 and then converted to a format where they can be displayed on the TV set 32. The user is then able to view digital images residing on the computer memory on the TV set and the computer only need to within wireless range which typically can be over 100 feet indoors.

In the embodiment of the invention shown in FIG. 1, the transmit assembly 22 interfaces with computer 26 however, the transmit box could interface with any device which contained or stored digital images. For example, the transmit assembly 22 could interface directly with a digital still image camera 30.

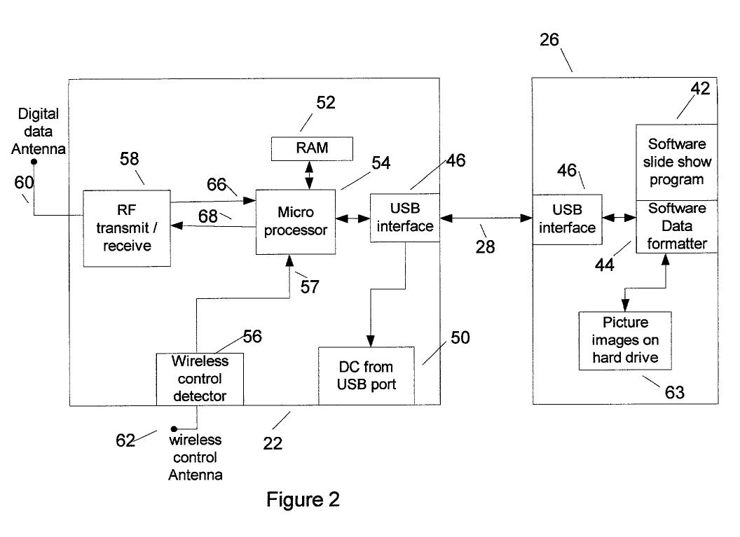

Details of one embodiment of the invention transmit assembly 22 and computer 26 functions are shown in FIG. 2. A software program 42 which has some “slide show” functionality is running on the computer 26. The software program 42 is controlled either by the keyboard or the computer mouse or from commands from the transmit box 22 over the bus interface 28. When the software program is instructed to send a digital image to the transmit assembly 22, it first formats the picture for optimum transmission. Formatting includes optimum compression of data and also optimum viewing size for utilizing the TV screen.

Many different compression methods are available for the digital image but one compression method to consider is the JPEG format. The JPEG format has 16-bit color resolution which is higher than the CCIR 601 digital video standard but it's interesting regardless. Achieving full resolution on a TV screen requires on the order of 100 dots per inch and with reasonable compression, a file size for the image to be displayed with good resolution on the TV screen is on the order of 30 Kbytes. The software data formatter 44 may also manipulate the image to optimize its displayed size on the TV screen. Another good option for a digital image compression format is JIF as this contains less color resolution and may be more than adequate for the TV display and result in smaller transmitted file size.

In the preferred embodiment, the formatted digital image is then sent from the computer 26 to the transmit assembly 22 over the data bus 28. USB interface 46 in the transmit box 22 interfaces with USB interface 46 in the computer 26. A microprocessor 54 in the transmit assembly 22 controls the flow of digital data. Random Access Memory RAM 52 is used to store digital data during data wireless transmission and to also can store a “queue” of digital image data. For example, the last picture viewed, the present picture viewed and the next picture to be viewed might be stored in RAM 52 and as one picture is being transmitted on the RF link, the next picture may be downloaded from the computer hard drive in preparation for the next transmit.

The microprocessor 54 also reads in control data 57 signals from the wireless control detector 56 which receives the RF signal on the wireless control antenna 62. In one embodiment of the design, this is an AM or “on off keyed” OOK detector and demodulates the RF signal from the remote control. The demodulated signal logic level may be encoded by the time length of the RF pulse. For example, a 500 usec pulse may represent logic high and a 1500 usec pulse may represent a logic low. Because the data in this transmission is for control only with a relatively low amount of information and typically has a very low duty cycle, it can operate in the 300 to 400 Mhz regions in the U.S. This demodulated signal is decoded by the microprocessor and typically might contain information such as “display the next digital image” but could also contain other information such as navigating a menu displayed on the TV screen. The wireless control detector 56 may have its own RF wireless control antenna 62 or may share the digital data antenna 60. Forms of modulation other than AM could be used and the wireless control detector 56 could even be an integration of the data transmit and receive 58 function in a shared bus architecture.

The microprocessor 54 also sends data to the RF transmit/receive 58 over data out 68 and data in 66 and the RF signal is transmitted on digital data antenna 60. Because this is a high duty cycle data transfer, the transmit frequency will typically be in the 49.82 Mhz to 49.9 Mhz band or the 902 Mhz to 928 Mhz Industrial, Scientific and Medical (ISM) band or in the 2.4 Ghz band (in the USA, useable frequencies for this application vary in other countries). In the preferred embodiment, the RF data transfer will operate in either the 902 Mhz to 928 Mhz band or the 2.4 Ghz band simply because there is likely less interference and more bandwidth available. In one embodiment of the invention, we may require that the 30 Kbyte digital image be transmitted in 2 seconds. This requires a data transfer rate of 120K bits/second. However, because the data must be formatted to contain clocking information and also to have an average DC level or zero, it may likely have an encoding scheme such as Manchester which effectively doubles the “bit rate”. We therefore need an actual bit rate of 240K bits/second on the data transfer. Many modulations schemes can be used such as coherent or noncoherant amplitude shift keying (ASK), coherent or non-coherent frequency shift keying (FSK), differential phase shift keying (DPSK) quadrature phase shift keying (QPSK) or any other modulation scheme used to wirelessly transmit digital data. These methods may also be employed with various spread spectrum techniques such as frequency hopping spread spectrum. With this technique, the data transmission is divided into packets which are transmitted individually. As the transmission takes place, the frequency hops back and forth between pre-defined frequency channels.

However, at a 240 Kbit per second data rate, frequency shift keying can be inexpensively used with off the shelf integrated components in the 902 Mhz to 928 Mhz ISM band. Also, with the remote control having a low data rate and duty cycle requirement, it is also possible to allow both the 900 Mhz image data transfer and the 300 to 400 Mhz remote control to both be in operation at the same time which can simplify hardware requirements with the resulting cost benefits.

The power for the transmit assembly 22 can either come from an external source such as a wall transformer or in the preferred embodiment, it is received through the data bus connection such as is possible with DC from USB port 50. Note that some of the function in the computer or the transmit box 26 could be interchanged. For example, the software data formatter 44 function could reside in the transmit assembly 22.

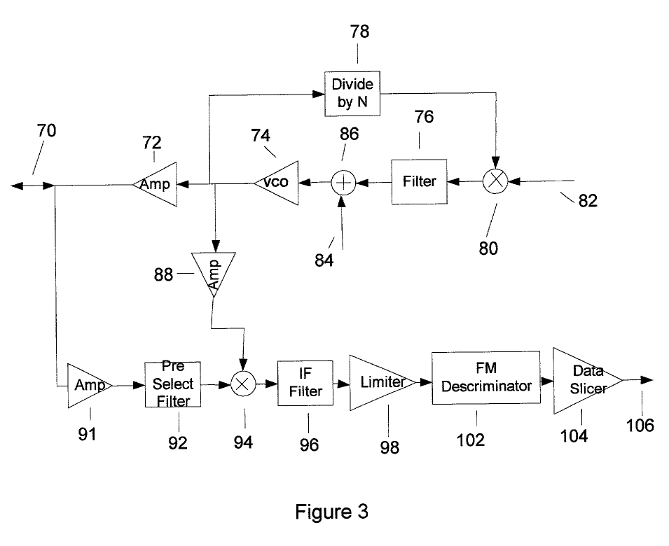

FIG. 3 shows one embodiment of the RF transmit/receive 58. This is a half duplex scheme which means that the function can either transmit or receive but cannot do both simultaneously. On the transmit function, a frequency reference 82 provides a high accuracy and stable frequency reference. A phase lock loop composed of phase detector 80, filter 76, data input summer 86, voltage controlled oscillator (VCO) 74 and divide by N 78. The frequency output of the VCO 74 is then at N times the reference frequency. The data input signal 84 is above the phase lock loop bandwidth and therefore creates a modulation of the VCO 74 frequency. The data input must in general not contain a DC component with this type of FSK modulation which is why an encoding method such as Manchester is commonly used. The FSK modulated signal is then amplified by the amplifier 72 and goes out as an RF in/out 70 which couples to an antenna.

In the receive mode, the data input signal 84 signal is shut off resulting in the output of VCO 74 being a discrete frequency. This is buffered by amplifier 88 to become a local oscillator for mixer 94. The RF input output 70 RF signal is amplified by amplifier 91 and then goes through a pre select filter 92 and then into mixer 94 which beats with the local oscillator to create an intermediate IF frequency which is composed of the sum and difference of the local oscillator and input RF signal. The IF frequency goes through an IF filter 96 which is commonly a ceramic filter with a center frequency of 10.7 Mhz. The output of the IF filter 96 goes into a limiter 98 which give the circuit high dynamic range and then into an FM discriminator 102 which turns the frequency modulation into an amplitude modulation. Finally, the data slicer 104 turns the amplitude modulation into a logic level signal which is the data out 106.

Typically data is sent in packets. In this case, packets could contain construction bytes for the compressed digital image or control bytes or any other sort of information, possibly even HTML coding if a web type of browser were implemented in the receive assembly 24 in order to display picture and text in a web browser format.

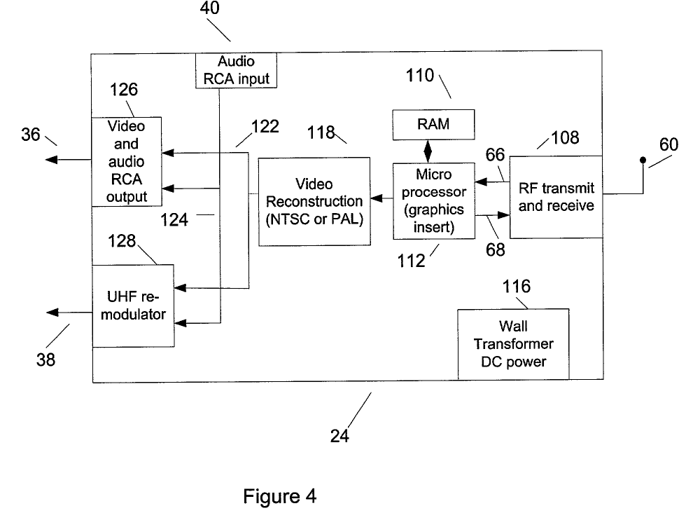

FIG. 4 is a block diagram of the receive assembly 24. The RF signal from and to the transmit assembly 22 interfaces to the RF transmit and receive 108 block through RF digital data antenna 60. The transmit and receive block 108 can be similar in function to the circuit described in FIG. 3. Digital data in and out of the RF transmit and receive block 108 is interfaced to the microprocessor 112. This microprocessor 112 decodes the clock and data if for example, the modulated signal was Manchester encoded and then re-constructs data packets into a digital image file which may be stored in RAM 110. Also, the microprocessor must de-compress the digital image to a bit mapped format which may also be stored in RAM 110 as for example a CCIR601 digital video frame. De-compression of images such as JPEG are done by well documented algorithms and can be hardware implemented in separate or integrated circuits or done by software running on a microprocessor. Another function of the microprocessor 112 is to output the bit mapped digital image frame to a video reconstruction block 118. The microprocessor also creates the video timing signal for the video reconstruction block 118. The microprocessor 112 may also insert the proper data into the bit-mapped frame in order to create on screen graphics in the reconstructed video image that will eventually be sent to the TV. The video reconstruction 118 has color sub carrier modulators, digital to analog conversion and filtering and timing signal construction to create the composite NTSC, PAL or SECAM video signal 122. Because of the number of functions the processor 112 must accomplish, it may be reasonable to implement this with more than one process dedicated microprocessors.

Audio may be sent over as part of the digital data stream in for example in MP3 format. Some slide show software programs allow audio to be edited in with the picture slide show and this could be transmitted with the digital image as fir example transport packets. The receive assembly 24 micro processor 112 would then reconstruct the audio signal and send it to an audio de-compression circuit where the output could be added to the video to create the synchronized audio and video signal.

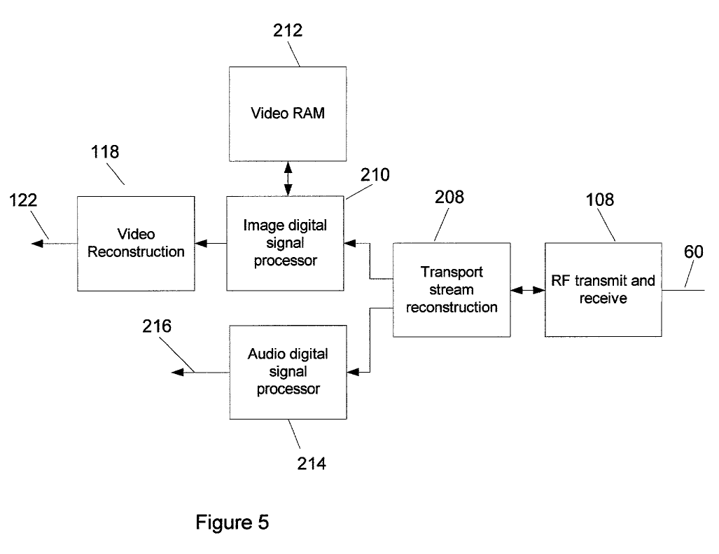

FIG. 5 shows a more detailed embodiment of the digital data manipulation in the receive box 24. The RF transmit and receive 108 receives and demodulates the digital data. Normally data will be sent in a packetized format and each packet may contain control, image, on screen graphics or audio data. Transport stream reconstruction 208 then decomposes the incoming bit stream and evaluates each packet and reconstructs the individual data streams. For example, digital image data packets are reconstructed from the incoming data stream, and the digital image data bytes are sent to the Image digital signal processor 210. Likewise, packets containing compressed audio data are reconstructed and sent to the Audio digital signal processor 214. The image digital signal processor 210 then takes the compressed digital image file (for example in JPEG format) and de-compresses the data to for a example a bit map format where each pixel to be displayed is represented by digital data words. This bit map digital data representing an image is stored in Video RAM 212. The video reconstruction 118 then creates an analog standard video representation on the bit map data as previously described. The audio digital signal processor 214 takes compressed audio which might be in any format (such as DOLBY AC3, Musicam or MP3 formats), decompresses the audio to a real time byte stream and then converts the digital data to an analog audio format.

In the embodiment shown in FIG. 4, audio is not part of the transmitted signal from the transmit assembly 22. However, it may be that the user wishes to have audio present with the video if for example, the slide show with audio is being recorded on a VCR. In this case, audio is input through external analog audio input 40 from an external source such as a tape deck or CD disk audio player. The analog audio signal 124 is combined with the video signal 122 and either output on a baseband audio and video output 126 which may be an RCA jack. Also, the baseband audio and video signal is input into a UHF remodulator 128 which outputs an RF UHF signal similar to terrestrial TV transmissions. The receive assembly 24 is powered though an external DC source such as a wall transformer DC power 116 or an internal power source.

The RF transmit and receive blocks 108 and 58 are shown as having two way data communication and may be implemented as shown in FIG. 3 or use an existing network solution such as Bluetooth, 802.11b, or HomeRF for example. However, it is also reasonable to simplify the system such that the RF function in the transmit assembly 22 is only capable of sending out and RF data signal and the RF function in the receive assembly 24 is only capable of receiving the RF data signal. While there may be uses for full two-way communication between the two boxes such as verification that data was received, it is not a critical data connection for this embodiment and would work fairly robustly with a simple one-way data path.

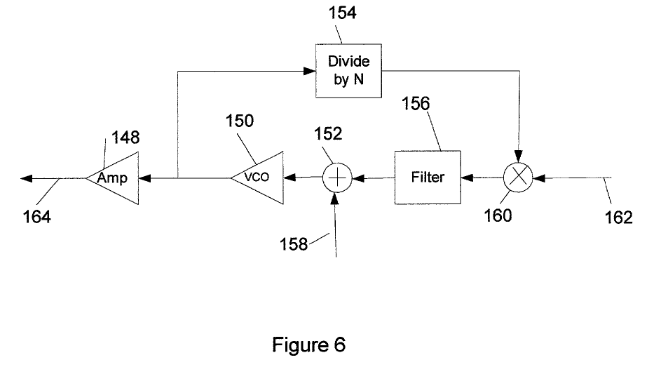

FIG. 6 shows the RF function for the transmit assembly 22 as a transmit only circuit. A frequency reference 162 provides a high accuracy and stable frequency reference. A phase lock loop composed of phase detector 160, filter 156, data input summer 152, VCO 150 and divide by N 154. The frequency output of the VCO 150 is then at N times the reference frequency 162. The data input signal 158 is above the phase lock loop bandwidth and therefore creates a modulation of the VCO 150 frequency. Similar as was described in FIG. 3, the data input must in general not contain a DC component with this type of FSK modulation which is why an encoding such as Manchester is commonly used. The FSK modulated signal is then amplified by the amplifier 148 and goes out as an RF output 164 signal. Because the output center frequency is the divide by N 154 value times the reference frequency 162, transmitted frequency hopping is commonly accomplished by changing the value of the digital divide by N 154. With this FM modulator, the minimum change in frequency will be then equal to the reference frequency 162.

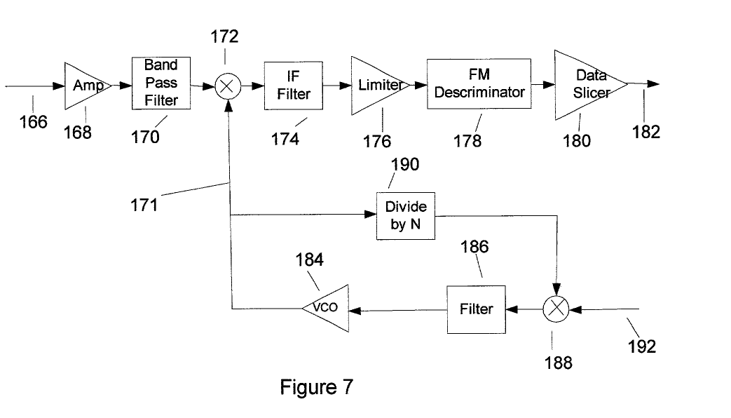

In the receive assembly 24, the implementation of the RF transmit and receive 108 as a receive only function is shown in FIG. 7. A local oscillator 171 is created by a phase lock loop consisting of reference frequency 192, phase detector 188, filter 186, VCO 184 and divide by N 190. The output frequency of the local oscillator 171 is determined by the multiplication of the divide by N 190 and the incremental change in the local oscillator will be at the reference frequency 192. The input RF signal 166 is amplified by amplifier 168 and then goes through a pre select filter 170 which removes out of band frequency components which might reduce the sensitivity of the circuit. The signal then goes into mixer 172 which beats with the local oscillator 171 to create an intermediate frequency which is the sum and difference of the two signals. The IF frequency goes through an IF filter 174 which is commonly a ceramic filter with a center frequency of 10.7 Mhz. The output of the IF filter 174 goes into a limiter 176 which gives the circuit high dynamic range and then into an FM discriminator 178 also operating at the IF frequency, which turns the frequency modulation into an amplitude modulation. Finally, the data slicer 180 turns the amplitude modulation into a logic level signal which is the data out 182.

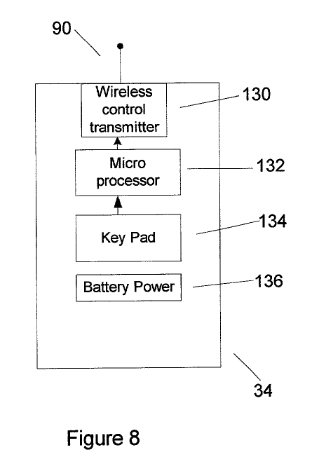

The remote control used for the remote RF control function is shown in FIG. 8. Because the unit will normally be hand held, it is run on battery power 136. A key pad 134 interfaces with microprocessor 132 which decodes the key pad entries and sends out a modulated power signal to the wireless control transmitter 130. This application must be low power to conserve batter life so the wireless control transmitter 130 typically is an oscillator circuit with center frequency determined by a crystal or ceramic resonator. The wireless control oscillator oscillates at the desired center frequency when power is applied and is dormant when power is not applied thereby conserving battery life.

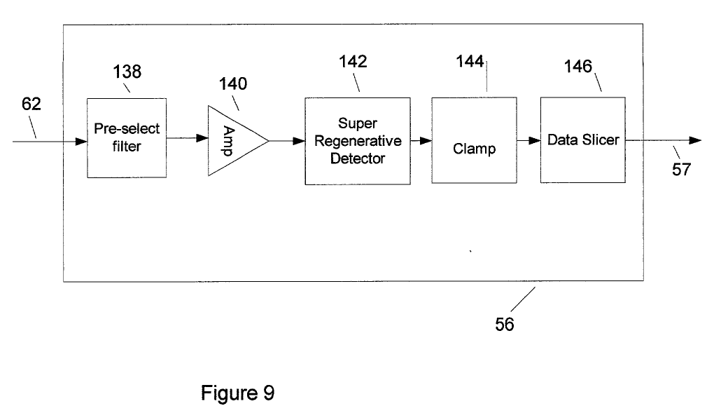

One embodiment of the wireless control detector 56 shown in FIG. 2 is described in FIG. 9. The design of the wireless control detector 56 can be implemented in many ways but very simple super regenerative circuits have been successfully and inexpensively used. Because this is for a remote control function, the data rate is slow and on off or amplitude modulation gives a reasonable working distance between the remote control 34 and the receive assembly 22. The RF signal transmitted from the remote control 34 is received with Wireless control antenna 62. The RF signal goes into a pre select filter 138 which attenuates out of band noise. The pre select filter may be designed with a notch frequency response at the data link frequency to minimize the data link frequency affects on sensitivity. An amplifier 140 amplifies and buffers the signal before it enters a super regenerative AM detector 142. This is a tuned circuit demodulates the input signal and creates a representation of the final output signal. In this embodiment, the signal then goes into clamp 144 where a DC level is established that data slicer 146 uses to create a logic level data output 57.

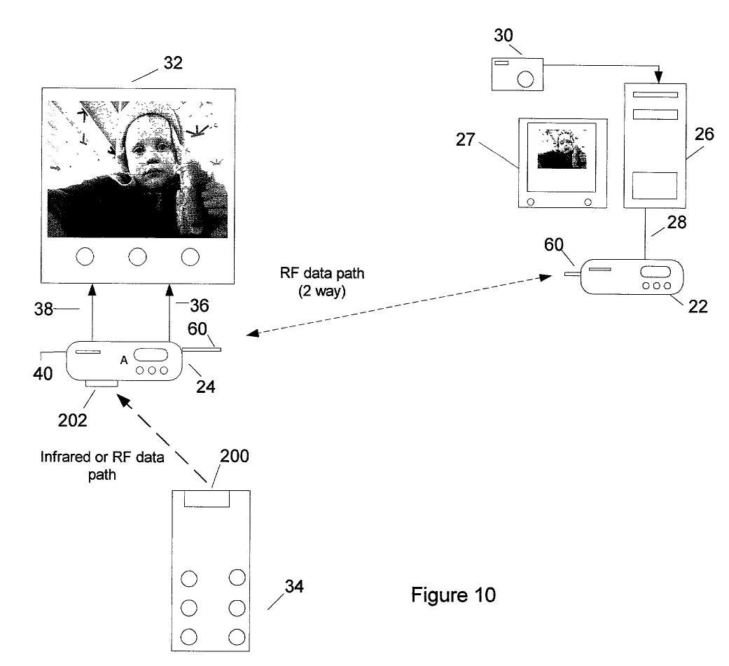

Another embodiment of this invention uses an infrared remote to communicate with the receive assembly 24 and is shown in FIG. 10. The remote control 34 no longer has a wireless RF emitter and instead utilized an infra red IR emitter 200. In the receive box 24 which is near the TV, there is an Infrared detector 202 which is capable of receiving the IR input and outputting the IR digital data 204 which is sent to the microprocessor 112. IR emitters typically use a pulse position data scheme where for example a logic zero is a 500 usec pulse and a logic one is a 1000 usec pulse. The pulse is created by modulating the infra red light source at between 30 KHz and 50 KHz however other frequency ranges could be used. The infrared detector 202 typically consist of an infrared sensor followed by a band pass filter centered around the modulation frequency and then a AM detector which converts the modulated signal to an envelope signal which is the data output. The configuration shown in FIG. 10 is convenient as the user is normally within optical viewing of the TV where the receive assembly 24 is placed near the TV set. The control signal from the remote 34 must still get to the transmit assembly 22 as the transmit assembly 22 has the interface to the computer where the software program is running and this will not necessarily be within optical viewing distance of the remote control. This then requires that the RF link between the transmit box and the receive box be two way. This configuration is interesting because as the popularity of two way RF networks goes up, the price will come down and at some point, this configuring may be less expensive to implement that the system described where the remote control 34 has a wireless connection to the transmit assembly 22 and the wireless connection between the transmit assembly 22 and the receive assembly 24 can be a one way wireless data path.

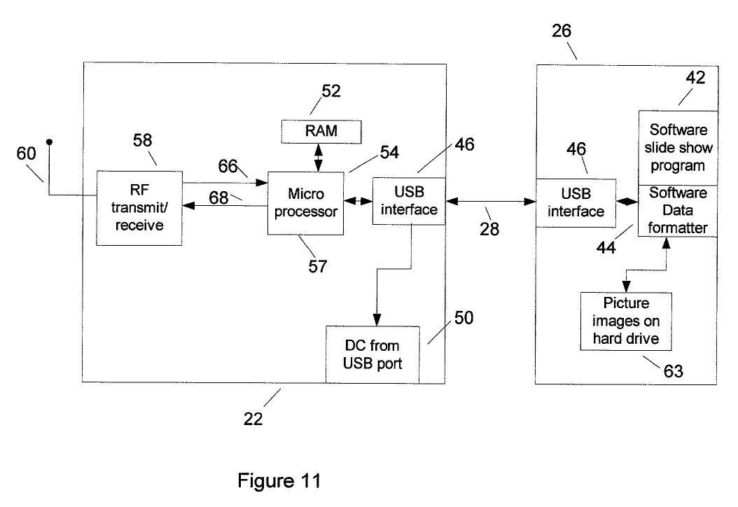

FIG. 11 shows the transmit assembly 22 with the wireless control detector 56 removed. In this embodiment, control signals and sent to the transmit assembly 22 over the two way RF transmit and receive functions 58 and 108. The two way RF transmit and receive may be full duplex which allows simultaneous communication in each directly by utilizing instantaneous separate frequencies for the two directions. This communication path may be half duplex where only one of the two communications directions occurs at a time and this implementation can generally be less expensive. A variety of modulation schemes can be once again used to support the data transmission.

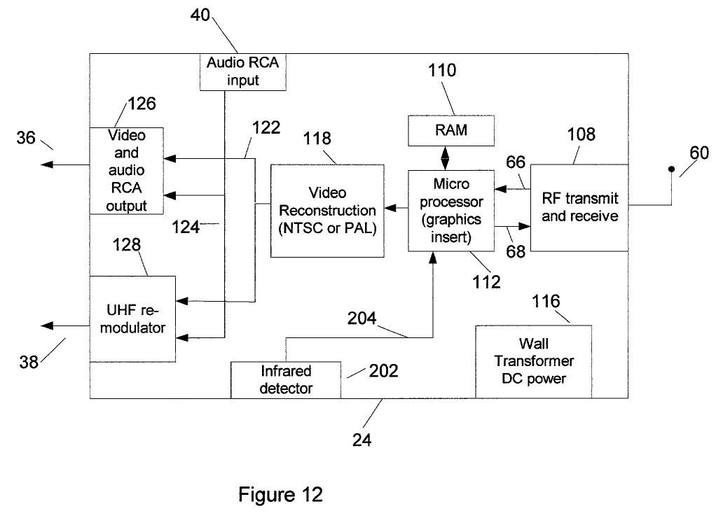

FIG. 12 shows the receive assembly 24 with the infrared detector 202 included.

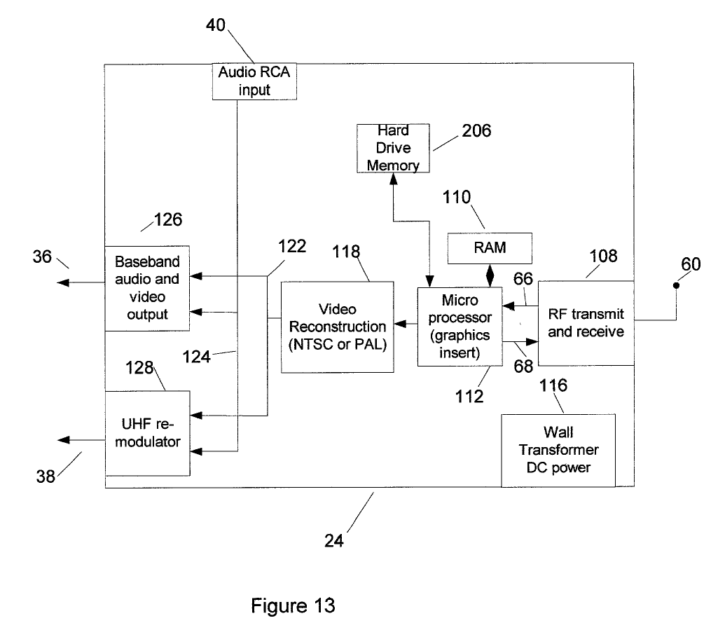

One final embodiment mentioned is shown in FIG. 13. In this figure, hard drive memory 206 has been added. This would allow the receive assembly 24 to permanently store digital images which had wirelessly transmitted from the transmit assembly 22. The hard drive memory 206 would allow stand alone viewing of digital images with the computer interface but the rest of the system would still allow a very convenient method of getting the pictures to the hard drive.

Also noted is that the transmit assembly shown in FIG. 11 could be implemented with a wireless network card or assembly such as Bluetooth, 802.11b, or HomeRF. Then, the wireless picture viewer could then utilize a wireless network card connected to the computer, which contained the digital images. The receive assembly 24 would then be just a node on the network. Because the network has two way communications, the remote control 34 would only need to transmit in infrared to the receive assembly 24 as shown in FIG. 10.

Summary, Ramifications and Scope

Thus, the reader will see that the invention described provides a convenient and robust method for displaying digital images, which tend to reside on computer hard drives on a TV set. The sequencing of pictures is controlled with a remote control and a feature is that the computer need only be within wireless distance from the remote control and TV set rather than in the same room or within visible distance. Also, since the image is transmitted in a digital format, it tends to be more immune to noise sources inherent in wireless transmissions.

While the above description contains many specificities, these should not be construed as limitations on the scope of the invention, but rather as an exemplification of several preferred embodiment thereof. Many other variations are possible. For example, in the preferred embodiment, the image files were primarily contained on a computer hard drive however; the image files could be contained on a camera memory or an image data-logging device. Also, the images are displayed on a TV set however, the images could be displayed on any sort of image producing device such as computer monitors or image projectors.

Accordingly, the scope of the invention should be determined not by the embodiments illustrated, but by the appended claims and their legal equivalents.

1. An apparatus system for wirelessly transferring digital image data and providing a signal to a video monitor for viewing digital image data comprising;
a) A data storage and control device containing digital image data stored in digital memory,
b) A transmit assembly with an interface to said data storage and control device, said interface enabled with two way digital data communication, said transmit assembly containing a means for wirelessly transmitting digital data to a receiver assembly and a means for wirelessly receiving digital data from a remote control, said transmit assembly contains a control means for controlling the flow of input and output data with said data storage and control device and for control and formatting of data wirelessly sent on said means for wirelessly transmitting digital data and received on said means for wirelessly receiving digital data,
c) A receive assembly with a video signal interface to a video monitor, said receive assembly contains a means for wirelessly receiving digital data from said transmit assembly, a method for converting said received digital data into a video format viewable on said video monitor, said receive assembly contains a control method which interprets a portion of said digital data from said transmit assembly for control of the display of the video signal.
d) A remote control containing a human interface, said remote control contains a means for wirelessly transmitting digital control data to said transmit assembly for the purpose of controlling the flow of digital data between said data storage and control device, said transmit assembly and said receive assembly.

2. Claim 1 where said data storage and control device is a computer with a memory device.

3. Claim 1 where said data storage and control device is a digital image camera with a memory device.

4. Claim 1 where said remote control wireless data transmission to the transmit assembly occurs at a separate RF frequency than said wireless data transmission from the transmit assembly to the receive assembly.

5. Claim 1 where said signal to the video monitor is an analog format such as NTSC, PAL or SECAM.

6. An apparatus for wirelessly transferring digital image data and providing a signal to a video monitor for viewing digital image data comprising;
a) A data storage and control device containing digital image data stored in digital memory,
b) A transmit assembly with an interface to said data storage and control device, said interface enabled with two way digital data communication, said transmit assembly containing a means for wirelessly transmitting digital data to a receive assembly and a means for wirelessly receiving digital data from a receive assembly, said transmit assembly contains a microprocessor for controlling the flow of input and output data with said data storage and control device and for control of data wirelessly sent on said means for wirelessly transmitting digital data and said means for wirelessly receiving digital data,
c) A receive assembly with a video signal interface to a television monitor, said receive assembly contains a means for wirelessly receiving digital data from said transmit assembly, a method for wirelessly transmitting digital data to said transmit assembly, a means for receiving wireless data from a remote control, a method for converting said received digital data that is comprised on digital image data into a video format viewable on a television monitor
d) A remote control containing a human interface, said remote control contains a means for wirelessly transmitting digital data to said receive assembly for the purpose of controlling the flow of digital data between said data storage and control device, said transmit assembly and said receive assembly.

7. Claim 6 where said data storage and control device is a computer with a memory device.

8. Claim 6 where said data storage and control device is a digital image camera with a memory device.

9. Claim 6 where said remote control wireless data transmission to said receive assembly uses infrared light as a transmission medium.

10. Claim 6 where said remote control wireless data transmission to the receive assembly occurs at a separate RF frequency than said wireless data transmission between the transmit assembly and the receive assembly.

11. Claim 6 where said signal to the video monitor is an analog format such as NTSC, PAL or SECAM.

12. An apparatus for wirelessly transferring digital image data and providing a signal for viewing digital image data comprising;
a) A data storage and control device containing memory with stored digital image data, said data storage and control device has an interface to a wireless network assembly enabled with two way digital data communication, said data storage and control device has a means for controlling the transfer of said digital image data to a wireless network assembly,
b) A wireless network assembly with a physical interface to said computer, said wireless network assembly is able to wirelessly send and receive digital data to at least one other second wireless network assembly,
c) A second wireless network assembly, said second wireless network assembly is able to send and receive digital data from said first wireless network assembly, said second wireless network assembly has a physical interface to a receiver assembly for sending and receiving digital data,
d) A receive assembly with an signal interface to a television monitor, said receive assembly contains a means for sending and receiving digital data from said second network assembly, a means for receiving wireless data from a remote control, a method for converting said received digital data that is comprised of digital image data into a video format viewable on a television monitor
e) A remote control containing a human interface, said remote control contains a means for wirelessly transmitting digital data to said receive assembly for the purpose of controlling the flow of digital data between said data storage and control device, said first and second wireless network assemblies and said receive assembly.

13. Claim 12 where said data storage and control device is a computer with a memory device.

14. Claim 12 where said data storage and control device is a digital image camera with a memory device.

15. Claim 12 where said remote control wireless data transmission to said receive assembly uses infrared light as a transmission medium.

16. Claim 12 where said remote control wireless data transmission to the receive assembly occurs at a separate RF frequency than said wireless data transmission between the transmit assembly and the receive assembly.

17. Claim 12 where said signal to the video monitor is an analog format such as NTSC, PAL or SECAM.
